(19) United States
(12) Patent Application Publication
(10) Pub. No.: US 2026/0320171 A1
(43) Pub. Date: Oct. 15, 2026

(54) EXTENDING VEHICLE DIGITAL KEY ACCESS CAPABILITIES FOR CONTROL OF ACCESS SECURED DEVICES IN A BUILDING VIA AN ECOSYSTEM CENTRAL HUB

(71) Applicant: GM GLOBAL TECHNOLOGY OPERATIONS LLC, Detroit, MI (US)

(72) Inventors: Ahmed F. Al Alawy, Canton, MI (US); Mohamed A. LAYOUNI, Macomb, MI (US); Azin NEISHABOORI, Plymouth, MI (US); Mustafa Hamada CHMEISEH, Shelby Township, MI (US); Venkata Naga Siva Vikas VEMURI, Farmington Hills, MI (US)

(21) Appl. No.: 19/176,323

(22) Filed: Apr. 11, 2025

(51) Int. Cl. G06F 21/45; G06F 21/30

(52) U.S. Cl. CPC G06F 21/45; G06F 21/305; G06F 2221/2111

(57) ABSTRACT

An access system for controlling operation of an access secured device includes: a telematics module of a vehicle configured to receive a command from a central hub of an ecosystem of a building or a mobile access device, where the command instructs the access secured device to perform an action, where the access secured device is located within, on or proximate to the building and is not in communication with the central hub, and where the ecosystem includes IoT devices at least one of connected to and controlled by the central hub; and a virtual key module configured to determine a location of the vehicle relative to the access secured device. The telematics module is configured, based on the location of the vehicle, to signal the access secured device to perform the commanded action.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to Internet of things (IoT) ecosystems, vehicle digital key access systems, and building access systems.

A home (or residential) ecosystem is an interconnected network of smart devices and can include a central hub and multiple IoT devices that wirelessly communicate with the central hub. Examples of a home ecosystem are Amazon Alexa®, Apple HomeKit®, and Google Home®. The IoT devices can include smart speakers, appliances, smart electrical plugs, smart lights, smart switches, etc. A user is able to control the status of the IoT devices via the central hub or via an ecosystem application executed on, for example, a mobile phone.

### SUMMARY

An access system for controlling operation of an access secured device is disclosed. The access system includes: a telematics module of a vehicle configured to receive a command from a central hub of an ecosystem of a building or a mobile access device, where the command instructs the access secured device to perform an action, where the access secured device is located within, on or proximate to the building and is not in communication with the central hub, and where the ecosystem includes IoT devices at least one of connected to and controlled by the central hub; and a virtual key module configured to determine a location of the vehicle relative to the access secured device. The telematics module is configured, based on the location of the vehicle, to signal the access secured device to perform the commanded action.

In other features, the virtual key module is configured to determine a distance of the vehicle relative to the access secured device, and based on the distance, signal the telematics module the distance. The telematics module is configured, based on the distance, to signal the access secured device to perform the commanded action.

In other features, the access secured device is located within or on the building and is not configured to communicate with the central hub.

In other features, the access secured device is a garage door opener, a door lock of the building, or a vehicle charger of the building.

In other features, the telematics module is configured to authenticate the central hub and negotiate a session key with the central hub and receive the command from the central hub including a message access code of the session key.

In other features, the access system further includes the central hub configured to i) authenticate an input device, which initiated the command, ii) negotiate another session key with the telematics module, and iii) transmit the command to the telematics module using the another session key, where the command is sent along with another message access code to the telematics module.

In other features, the telematics module is configured to authenticate the mobile access device and negotiate a session key with the mobile access device and receive the command from the mobile access device including a message access code of the session key.

In other features, the access system further includes the central hub configured to i) authenticate an Internet of things device, which initiated the command, ii) negotiate another session key with the mobile access device, and iii) transmit the command to the mobile access device using the another session key, where the command is sent along with another message access code to the mobile access device.

In other features, the access system further includes the central hub configured to receive the command from an Internet of things device and forward the command to the telematics module.

In other features, the access system further includes the central hub configured to receive the command from an Internet of things device and forward the command to the mobile access device. The telematics module is configured to receive the command from the mobile access device.

In other features, an access method for remotely accessing and controlling operation of an access secured device is disclosed. The access method includes: receiving at a telematics module of a vehicle a command from a central hub of an ecosystem of a building or a mobile access device, where the command instructs the access secured device to perform an action, where the access secured device is located within, on or proximate to the building and is not in communication with the central hub, and where the ecosystem includes IoT devices at least one of connected to and controlled by the central hub; determining a location of the vehicle relative to the access secured device; and based on the location of the vehicle, signaling the access secured device to perform the commanded action.

In other features, the access method further includes: determining a distance of the vehicle relative to the access secured device, and based on the distance, signal the telematics module the distance; and based on the distance, signaling the access secured device to perform the commanded action.

In other features, the access secured device is located within or on the building and is not configured to communicate with the central hub.

In other features, the access secured device is a garage door opener, a door lock of the building, or a vehicle charger of the building.

In other features, the access method further includes authenticating the central hub, negotiating a session key with the central hub, and receiving the command from the central hub including a message access code of the session key.

In other features, the access method further includes, via the central hub, i) authenticating an input device, which initiated the command, ii) negotiating another session key with the telematics module, and iii) transmitting the command to the telematics module using the another session key, where the command is sent along with another message access code to the telematics module.

In other features, the access method further includes authenticating the mobile access device, negotiating a session key with the mobile access device, and receiving the command from the mobile access device including a message access code of the session key.

In other features, the access method further includes i) authenticating an Internet of things device, which initiated the command, ii) negotiating another session key with the mobile access device, and iii) transmitting the command to the mobile access device using the another session key, where the command is sent along with another message access code to the mobile access device.

In other features, the access method further includes receiving the command from an Internet of things device and forwarding the command to the telematics module via the central hub.

In other features, the access method further includes receiving the command from an Internet of things device and forward the command to the mobile access device via the central hub, where the telematics module is configured to receive the command from the mobile access device.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example access system including a vehicle in communication with access secured devices and an ecosystem of a building in accordance with the present disclosure;

FIG. 2 is a functional block diagram of a first example communication pathway for controlling an access secured device in accordance with the present disclosure;

FIG. 3 is a functional block diagram of a second example communication pathway for controlling an access secured device in accordance with the present disclosure;

FIG. 4 is a functional block diagram of a vehicle including a telematics module and a virtual key module in accordance with the present disclosure;

FIG. 5 is a functional block diagram of devices along the first example pathway of FIG. 2 implementing certain communication protocols in accordance with the present disclosure;

FIG. 6 is a functional block diagram of the first example pathway of FIG. 2 illustrating signal transmission in accordance with the present disclosure;

FIG. 7 is a signal flow diagram illustrating implementation of a first method for controlling an access secured device and/or IoT device via a central hub and a vehicle using the first example pathway of FIG. 2;

FIG. 8 is a functional block diagram of devices along the second example pathway of FIG. 3 implementing certain communication protocols in accordance with the present disclosure;

FIG. 9 is a functional block diagram of the second example pathway of FIG. 3 illustrating signal transmission in accordance with the present disclosure; and

FIG. 10 is another signal flow diagram illustrating implementation of a second method for controlling an access secured device and/or IoT device via a central hub and a vehicle using the second example pathway of FIG. 3.

In the drawings, reference numbers may be reused to identify similar and/or identical elements.

### DETAILED DESCRIPTION

Each of the existing home ecosystems has a designated protocol for a central hub to communicate with IoT devices and mobile devices such as smart phones, smart watches, tablets, etc. Thus, if a homeowner has devices of different home ecosystems, then the homeowner needs to control the IoT devices of the ecosystems with multiple central hubs and/or applications.

Garage door openers are access secured devices that are not compatible with home ecosystems and thus a central hub and/or home ecosystem application are unable to control a state of a garage door (e.g., whether the garage door is open or closed). This can also hold true for other access secured devices, such as a home entrance door lock, a home vehicle charger for charging an electric vehicle, etc. For example, smart garage doors use near field communication or radio frequency (RF) communication. Home ecosystems implement: local area network (LAN) communication protocols; low-power, low-bandwidth, mesh networking protocols; and/or short-range wireless communication such as wireless fidelity (Wi-Fi™), Thread, and Bluetooth® communication. Because of these differences, users are unable to control garage doors and other access secured devices via IoT devices and/or a home ecosystem central hub.

In order for IoT devices manufactured by different manufacturers to communicate with a same central hub and/or to be controlled with a same single application executed on a single mobile device, the IoT devices and the central hub may be configured to communicate with each other using a Matter® protocol developed by the Connectivity Standards Alliance (CSA). However, the Matter protocol cannot be used to remotely access and control access secured devices, such as garage door openers, main door locks, vehicle chargers, etc.

The examples set forth herein include systems and methods for enabling control of access secured devices and IoT devices in a smart home ecosystem using a central hub and a vehicle to control the states of these devices. The examples bridge current gaps between home ecosystems and access secured devices and enable access secured devices to be controlled from a building (e.g., residential home, commercial building, or other building) IoT ecosystem and/or other IoT ecosystem. This includes utilizing digital key capabilities of a vehicle for communication with access secured devices and connectivity between an ecosystem central hub and a vehicle.

In some embodiments, locations of the access secured devices and IoT devices are determined to ensure that the devices are located inside a predetermined boundary around the home (or building) for control commands to be permitted and carried out. A connected vehicle and its digital key ranging capabilities are utilized as a bridge between i) an ecosystem central hub and ii) the access secured devices and/or IoT devices. This enables, for example, a voice command to be provided to a central hub (e.g., smart home hub) to lock or unlock a door, open or close a door, start charging of an electric vehicle, etc. These access secured devices are not directly reachable via the central hub using, for example, Matter protocols of a smart home network. The same is true for commands originating from a Matter endpoint device (e.g., phone, key fob, or smart button) connected to the smart home hub.

In an embodiment, the central hub authenticates an initiator device (e.g., a first IoT device or a mobile access device) and then securely relays a command to a vehicle, which engages in a ranging session with an access secured device or a second IoT device. If the measured range of the vehicle satisfies the location requirements and is consistent with a range of, for example, a mobile phone, then the vehicle issues a command to the access secured device or the second IoT device to perform an action. For example, a command may be sent from the vehicle to a garage door opener to open or close a garage door. As another example, a command may be sent from the vehicle to an entrance door lock of a building to lock or unlock the entrance door lock.

The examples disclosed herein allow an endpoint device (e.g., an IoT device or mobile access device) in or near a smart building (e.g., smart home or smart office building) to connect with an access secure device and/or another IoT device that it normally cannot reach (e.g., directly communicate with). Communication pathways are herein described for implementing these examples. The communication pathways are secure against tampering, forgery, replay, as well as distance reduction attacks.

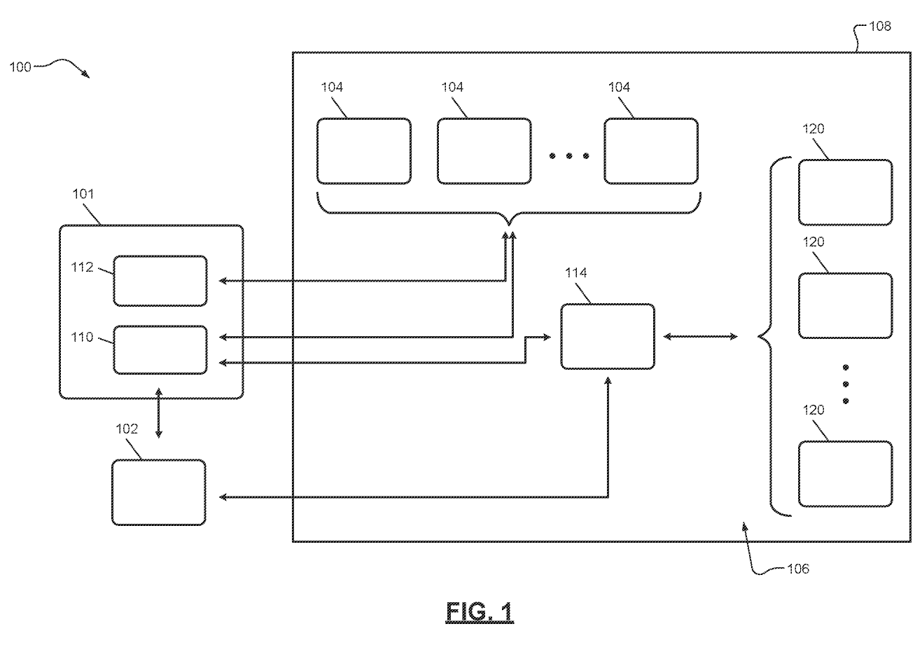

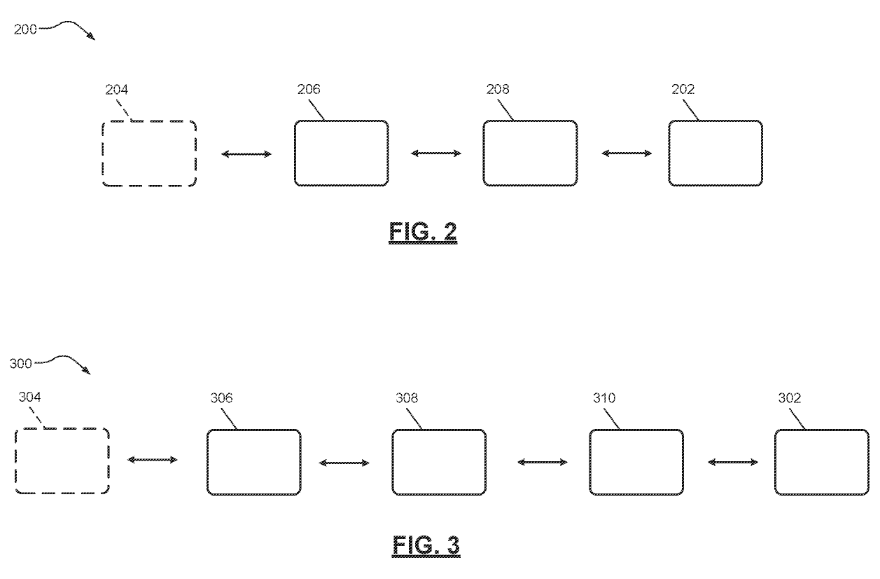

FIG. 1 shows an access system 100 including a vehicle 101 in communication with a mobile access device 102 and access secured devices 104 and an ecosystem 106 of a building 108. The vehicle 101 may include a telematics module 110 and a virtual key module 112, as well as other modules and devices, examples of which are shown in FIG. 4. The telematics module 110 communicates with the mobile access device 102, a central hub 114 of the ecosystem 106, and the access secured devices 104. The virtual key module 112 communicates with the access secured devices 104. The telematics module 110 communicates with the virtual key module 112. This communication is further described below with respect to the examples of FIGS. 2-3 and 5-10. The access secured devices 104 may include garage door openers, door locks, charging stations and/or other access secured devices, which are not configured to communicate with the central hub. The charging station (or vehicle charger) may be installed in the building, on a wall of the building, or be a separate charging station proximate to the building. The central hub 114 may be a home (or residential) hub, a commercial building hub, or other central hub with the corresponding ecosystem 106 including IoT devices 120. The IoT devices 120 may include speakers, Wi-Fi™ compatible devices, appliances (e.g., refrigerators, washers, dryers, ovens, etc.), lights, light bulbs, plugs, switches, buttons, etc. The access secured devices 104 may include IoT devices. An IoT device refers to a device that can connect to the Internet and share data.

In an embodiment, the central hub 114 implements a Matter® protocol developed by the Connectivity Standards Alliance (CSA). The Matter® protocol being a connectivity standard for devices such as IoT devices, mobile access devices, and/or vehicles to communicate with the central hub 114. The IoT devices may be referred to as Matter endpoints.

The ecosystem 106 may implement protocols of home ecosystems such as protocols of an Amazon Alexa® ecosystem, an Apple HomeKit® ecosystem, and/or a Google Home® ecosystem. The central hub 114 and the IoT devices 120 may be configured to operate and communicate according to one of these ecosystems. The central hub 114 may be in communication with a cloud-based server associated with one of these ecosystems.

FIG. 2 shows a first example communication pathway 200 for controlling an access secured device 202. The communication pathway 200 includes an input device 204, a central hub 206, a vehicle 208 and the access secured device 202. The central hub 206 and the vehicle 208 may represent the central hub 114 and the vehicle 101 of FIG. 1. The input device 204 may be an IoT device, a mobile access device (e.g., a mobile phone, a tablet, a wearable device, a key fob, etc.), a microphone, or other input device. In one embodiment, the input device 204 is not included and the central hub 206 directly receives an input (e.g., a voice command or touch-based input, such as a command via a touch screen). In an embodiment, the input device 204 generates commands when certain conditions exist. For example, when a sensed activity occurs, when a sensed proximity between two items satisfies a criterion (e.g., a mobile access device is within a predetermined distance of the vehicle 208), etc. Routines may be implemented to monitor the conditions and trigger generation of the commands.

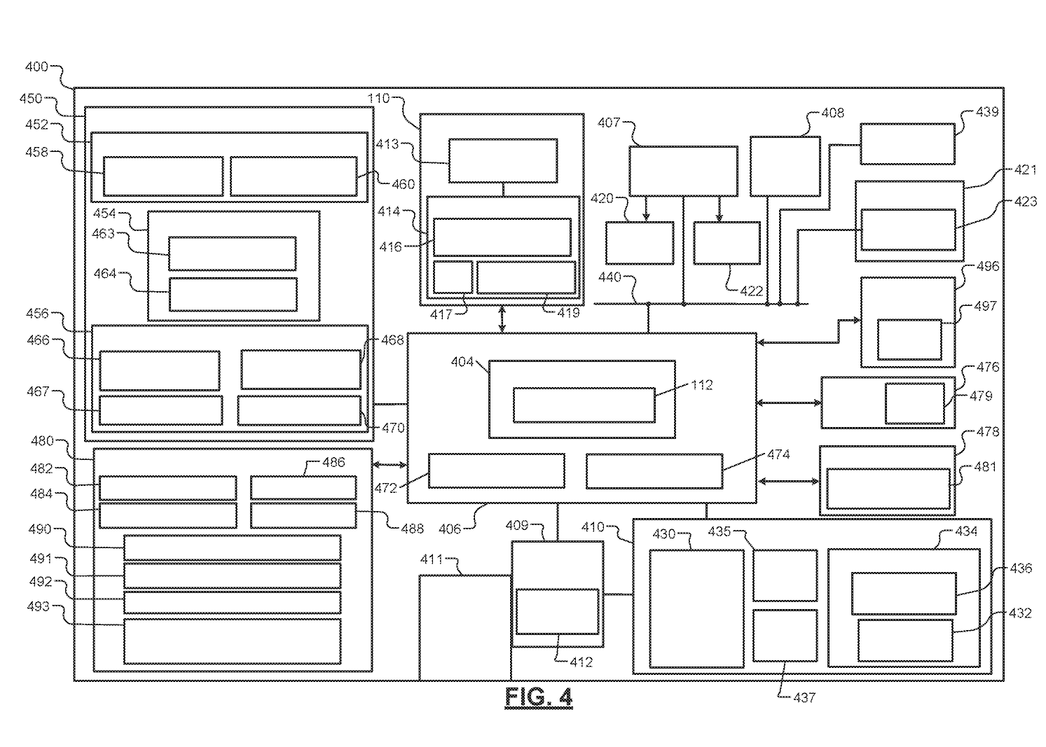

FIG. 3 shows a second example communication pathway 300 for controlling an access secured device 302. The communication pathway 300 includes an IoT device 304, a central hub 306, a mobile access device 308, a vehicle 310 and the access secured device 302. The IoT device 304, central hub 306, mobile access device 308, and the vehicle 310 may represent one of the IoT devices 120, the central hub 114, the mobile access device 102, and the vehicle 101 of FIG. 1. The input device 204 may be an IoT device, a mobile access device (e.g., a mobile phone, a tablet, a wearable device, a key fob, etc.), a microphone, or other input device. In one embodiment, the IoT device 304 is not included and the central hub 206 directly receives an input (e.g., a voice command or touch-based input, such as a command via a touch screen).

FIGS. 2-3 show workflow between IoT devices (or Matter endpoints) or other input devices and an access secured device 202 (e.g., a garage door or target IoT device). The first pathway of FIG. 2 may include a Matter endpoint (e.g., the input device 204). The Matter endpoint authenticates to the Matter Hub and negotiates a session key SessKey1. The Matter endpoint then sends a command to the access secured device 202 via the central hub along with a message authentication code (MAC) using the session key SessKey1. For each MAC referred to herein, a message identification code may use a session key to generate the MAC. The central hub 206 authenticates to a telematics module of the vehicle 208 and negotiates a second session key SessKey2. The central hub 206 then relays the command sent by the Matter endpoint to the access secured device 202 to the telematics module along with the MAC using the second session key SessKey2.

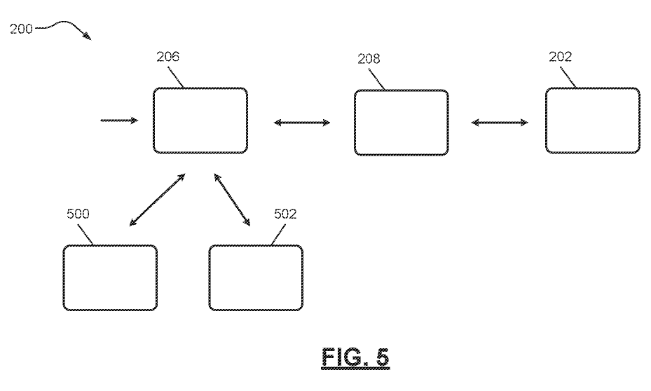

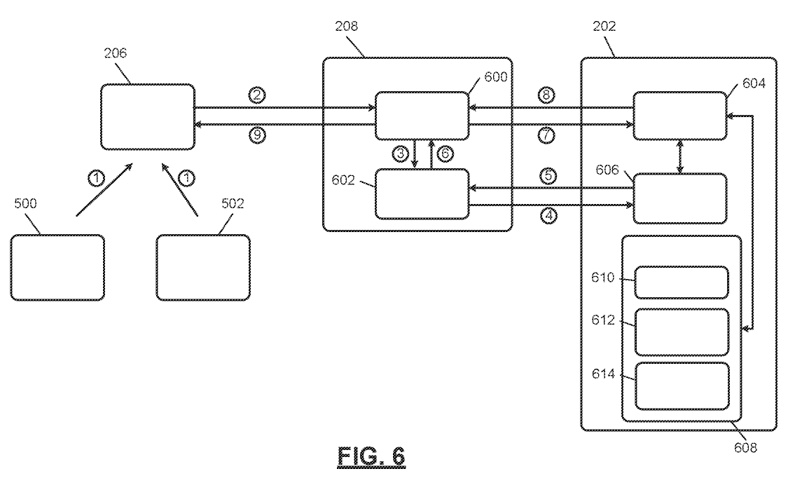

The telematics module instructs a virtual key module (VKM) of the vehicle 208 to locate the access secured device. The result of the location determination is returned to the telematics module and to an action module of the access secured device 202. If a distance between the vehicle and the access secured device 202 satisfies a location requirement (i.e., less than a predetermined threshold), then the telematics module instructs the action module to perform an action (e.g., lock or unlock, open or close, or other action) and relays an acknowledgment (ACK) or negative acknowledgement (NACK) signal to the telematics module. If the location requirement is not satisfied, the telematics module returns an error and/or NACK signal to the central hub. All feedback from the telematics module to the central hub 206 is MAC protected using the second session key SessKey2. Finally, the central hub 206 returns an ACK/NACK signal to the initiating matter endpoint device that is MAC-protected using the first session key SessKey1. This is further described below with respect to FIGS. 5-7.

The second pathway of FIG. 3 may include a Matter endpoint (e.g., the IoT device 304). The Matter endpoint authenticates to the central hub 306 and negotiates a first session key SessKey1. The Matter endpoint then sends to the access secured device 302 a command via the central hub 306 along with a MAC using the first session key SessKey1. The central hub 306 then authenticates to the mobile access device 308 and negotiates a second session key SessKey2. The central hub 306 then relays the command generated by the Matter endpoint for the access secured device 302 to the mobile access device 308 along with a MAC using the second session key SessKey2. The mobile access device 308 then may authenticate to the telematics module of the vehicle 310 and negotiate yet another (or third) session key or use the second session key SessKey2. The mobile access device 308 relays the command to the telematics module using the yet another session key or the second session key SessKey2. The telematics module instructs the VKM of the vehicle to locate the mobile access device 308. The result of the location determination is returned to the telematics module. If a distance between the vehicle and the mobile access device 308 satisfies a location requirement (e.g., the distance is less than a predetermined threshold), then the telematics module instructs the VKM to locate the access secured device, otherwise the telematics module aborts.

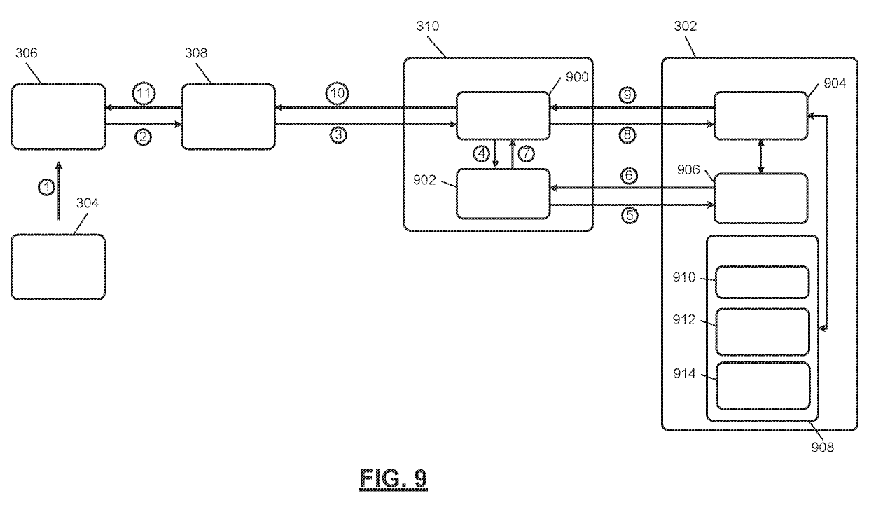

The VKM returns a second distance between the vehicle 310 and the access secured device 302 to the telematics module and the action module of the access secured device 302. If a location requirement (e.g., distance less than a second predetermined threshold) is satisfied for the second distance, then the telematics module instructs the action module to perform an action (e.g., lock or unlock a door) and relays its feedback (e.g., indication of action taken) to the mobile access device 308. However, if the location requirement is not satisfied, the telematics module returns an error to the mobile access device 308. All feedback from the telematics module to the mobile access device 308 and from the mobile access device 308 to the central hub 306 is MAC protected using a session key such as the yet another session key or use the second session key SessKey2. In an embodiment and for security reasons, each session key is unique per pair of devices (or nodes) and is not shared with any third device (or node). Thus, if a session key (e.g., the second session key SessKey2) was used previously between a first pair of devices (or nodes), a different session key would be used between a second pair of devices (or nodes). One of devices in the first pair of devices may be in the second pair of devices or the first pair of devices may both be different than the second pair of devices. Finally, the central hub 306 returns an ACK/NACK to the initiating matter endpoint that is MAC protected. This is further described below with respect to FIGS. 8-10.

In an embodiment and for added security, the vehicle checks a distance it measured between the vehicle and the access secured device (e.g., garage door opener), and compares the measured distance to a distance measured between the mobile access device and the access secured device. If both are consistent with one another, the vehicle issues an action command (e.g., an open or shut command) to be performed. This may result, for example, in the opening or closing of a garage door. In an embodiment, the distances are consistent when, for example, both the vehicle and the mobile access device are within a predetermined distance (e.g., 20-40 meters) of the access secured device. In an embodiment, the distances are consistent when, for example, a difference between the distances is less than a predetermined threshold (e.g., 5-20 meters). In an embodiment, this dual measurement consistency check is performed when the initiating device is requesting that the access secured device unlock or open a door. If the initiating device is requesting that the access secured device lock or close a door, then a dual measurement consistency check is not performed.

In an embodiment, the telematics module of the vehicle is digital key capable for communicating with an access secured device (e.g., a garage door opener, a door lock, etc.). The IoT initiating device, the central hub and the mobile access device may not be digital key capable and are able to control the access secured device by communicating with the telematics module. This extends vehicle capability to IoT devices, the central hub and the mobile access device. The vehicle may be wirelessly connected to a wireless network of a building (e.g., residential home), a central hub of the building, and door devices (e.g., garage door openers, door locks, etc.). The vehicle facilitates connections between smart home devices and door devices.

In both of the pathways of FIGS. 2-3, a vehicle facilitates connection between input devices (e.g., smart IoT devices, mobile access devices, a central hub, etc.) and an access secured device. For each pathway, a consistency check may be performed to gain access control of the access secured device. The consistency check includes comparing distances of a mobile access device and a vehicle relative to the access secured device, a central hub, and/or a reference point, as described herein. When the distances are consistent with each other, access control is provided.

FIG. 4 shows a vehicle 400, which may represent the vehicle 101 of FIG. 1. The vehicle 400 includes the telematics module 110 and the virtual key module 112. Although the virtual key module 112 is shown as being implemented as part of an access module 404 within a vehicle control module 406, the virtual key module 112 may be implemented separate from the vehicle control module 406. Some example operations of the modules 110, 112 are described herein with respect to FIGS. 1-10. The host vehicle 400 may be a partially or fully autonomous vehicle, a vehicle with assisted driving capabilities, or a non-autonomous vehicle.

The host vehicle 400 further includes one or more power sources 409, an infotainment module 407, other control modules 408 and a propulsion system 410. The vehicle control module 406 may control operation of the host vehicle 400 including the propulsion system 410 and other system described below. The power sources 409 may include one or more battery packs, a generator, a converter, a control circuit, terminals for high and low voltage loads, etc., as well as one or more battery sensors 412 for detecting states of the power sources 409 including voltages, current levels, states of charge, etc. A charging system 411 may be included for charging the power sources 409. The charging system 411 may be plugged into a building charging station and/or charger, as referred to herein.

The telematics module 110 provides wireless communication services within the host vehicle 400 and wirelessly communicates with access secured devices, service providers, network devices (e.g., cloud-based network devices, central office devices, and/or back-office devices), other vehicles, mobile devices, infrastructure devices, and other devices external and/or internal to the host vehicle 400. The telematics module 110 may support Wi-Fi®, Bluetooth®, Bluetooth Low Energy (BLE), Ultra-Wideband (UWB), near-field communication (NFC), cellular, legacy (LG) transmission control protocol (TCP), long-term evolution (LTE), and/or other wireless communication and/or operate according to Wi-Fi®, Bluetooth®, BLE, UWB, NFC, cellular, and/or other wireless communication protocols. The telematics module 110 may include one or more transceivers 413 and a navigation module 414 with a global positioning system (GPS) and GNSS (or Global Navigation Satellite System) receiver 416. The navigation module 414 may include an inertial measurement unit (IMU) 417 and an odometer/wheel sensor 419. The transceivers 413 wirelessly communicate with network devices internal and external to the host vehicle 400 including cloud-based network devices, central stations, back-offices, and portable network devices. The transceivers 413 may perform pattern recognition, channel addressing, channel access control, and filtering operations.

The navigation module 414 executes a navigation application to provide navigation services. The navigation services may include location identification services to identify where the host vehicle 400 is located. The navigation services may also include guiding a driver and/or directing the host vehicle 400 to a selected location. The navigation module 414 may communicate with a central station to collect map information indicating levels of traffic, transportation object identification and locations (e.g., locations and types of signs), path information, weather information, etc. As an example, if the host vehicle 400 is an assisted and/or automated driving vehicle, the navigation module 414 may direct the vehicle control module 406 along a selected route to a selected destination. The GPS and GNSS receiver 416 may provide: location information; velocity and/or direction (or heading) of the host vehicle 400, other vehicles, and objects (e.g., pedestrians and cyclists); and/or global clock timing information.

One or more HUDs (also referred to as augmented reality (AR) HUDs) 421 are included and may include one or more HUD control module(s) (one HUD control module 423 is shown). The HUD control module 423 is in communication with the modules 406 and may display information regarding devices within a building and ecosystem such as states of access secured devices and IoT devices. This may include states of these devices (e.g., open, closed, locked, unlocked, on, off, etc.)

The infotainment module 407 may include and/or be connected to an audio system 422 and/or a video system including one or more displays. The displays 420, 421 and audio system 422 may be part of a human machine interface. The displays 420, 421 may include cluster and/or center console displays, etc. Haptic devices (e.g., steering wheel and/or seat vibration devices) may be used in addition to the displays 420, 421 and the audio system 422 to interact with a vehicle occupant such as a driver or passenger. This interaction is further described below. Messages may be displayed, audibly played out, and/or indicated via the displays 420, 421, the audio system 422, the haptic devices, and/or via one or more other output devices.

The infotainment module 407 may provide various information, the above-stated device information, warnings, and proactive messages including: status information; routing information; whether driving operations are autonomously controlled, limited and/or prevented; gear shifter status; upcoming and currently being performed operations (e.g., braking, accelerating, turning operations); detected objects (or obstacles); vehicle status information; diagnostic information; prognostic information; entertainment features and information; etc. The infotainment module 407 may be used to guide a vehicle operator to a certain location, indicate trip estimations (e.g., distances to selected destinations), and other information.

The propulsion system 410 may include one or more torque sources, such as one or more motors and/or one or more engines (e.g., internal combustion engines). In the example shown in FIG. 1, the host vehicle 400 includes an engine 430 and one or more motors 432. The torque sources are independently controlled. The propulsion system 410 includes a motor control system 434 that includes the one or more motors 432 and a motor control module 436 that may control operation of the one or more motors 432 based on signals from the vehicle control module 411. The propulsion system 410 may include a gear selector and/or shifter 435 for setting a gear of a transmission 437 and/or for setting a drive state of one or more of the torque sources. The gear selector and/or shifter 435 may be an electronic selector (e.g., one or more electrical switches), a mechanical and/or electrical shifter, or other selector and/or shifter. The propulsion system 410 may be controlled based on position of an accelerator 439 (e.g., an accelerator pedal, a throttle plate, etc.).

The modules 110, 404, 406, 407, 408, 423 may communicate with each other directly or indirectly via one or more buses 440, such as a controller area network (CAN) bus and/or other suitable interface. The vehicle control module 406 may control operation of vehicle modules, devices and systems based on feedback from sensors 450 and information and/or instructions received from a cloud-based network device.

The sensors 450 may include exterior sensors 452, interior sensors 454, and other sensors 456. The exterior sensors 452 may include radar and/or lidar sensors 458 and imaging and audio devices (e.g., visual spectrum cameras, long-wave infrared cameras, short-wave infrared cameras, ambient light sensors, and microphone or microphone array) 460. The exterior sensors 452 may be used to detect objects external to the host vehicle 400 and/or in a path of the host vehicle 400. The objects may include lane markings and objects, other vehicles, pedestrians, bicyclists, etc. The exterior sensors 452 may include sensors for determining location and/or range of the vehicle 400 relative to an object and/or device.

The interior sensors 454 may include one or more interior imaging sensors (e.g., cameras) 463, and a microphone or microphone array 464. The interior sensors 454 may be part of a driver monitoring system (DMS). The cameras 463 may be used to detect, track and/or monitor vehicle occupants including detecting locations of vehicle occupants in the vehicle, anatomical features (e.g., face, arms, hands, legs, etc.) of the vehicle occupants, head locations and/or eyes, etc. The interior sensors 454 may be used to detect gaze directions of a driver and/or vehicle occupants. The interior sensors 454 may include door sensors, seat belt sensors, seat sensors, etc. The door sensor may indicate whether a door is open or closed. The seat belt sensors may indicate whether seat belts are buckled. The seat sensor may include, for example, load sensors, strain gauges, and/or piezoresistive or piezoelectric sensors for detecting whether an occupant is in a particular seat and the weight of the occupant.

The other sensors 456 may include a gear selector and/or shifter sensor 467, a vehicle speed sensor 466, acceleration sensors (e.g., longitudinal and lateral acceleration sensors) 468, and a fuel level sensor 470, as shown, and other sensors. Additional sensors may also be included such as brake system sensors (a brake sensor 479 is shown) and steering system sensors (a steering angle sensor 481 is shown). The gear selector and/or shifter sensor 467 generates a signal indicative of a state of the gear selector and/or shifter 435.

The vehicle control module 406 may also include a mode selection module 472 and a parameter adjustment module 474. The parameter adjustment module 474 may be used to adjust parameters of the host vehicle 400. The vehicle control module 406 may perform autonomous operations based on interaction with a vehicle occupant. As an example, the vehicle control module 406 may operate in a fully or partially autonomous mode and may control the propulsion system 410, a brake system 476, and a steering system 478. In an embodiment, the vehicle control module 406 controls operation of the systems 410, 476 and 478 based on or without interactions with a vehicle occupant. The vehicle control module 406 may i) perform autonomous operations such as steering, braking, accelerating, etc., and/or ii) display and/or audibly playout messages, perform haptic operations via haptic devices, and/or output messages and/or corresponding signals via other output devices.

The host vehicle 400 may further include the memory 180. The memory 480 may store sensor data 482, parameters 484, applications 486, algorithms 488, historical data 490, on-board inputs 491, off-board inputs 492 from other devices external to the host vehicle 400 and other data 493. The sensor data and parameters may include access secured device locations, mobile access device locations, host vehicle locations, occupant locations, occupant weights, occupant heart rates, host and other vehicle locations, vehicle speed, vehicle acceleration, battery state of charge, fuel level, etc. applications 486. The applications 486 may include applications executed by the modules 110, 112, 406-408.

Although the memory 480 and the vehicle control module 406 are shown as separate devices, the memory 480 and the vehicle control module 406 may be implemented as a single device. The memory 480 may also store historical data 490 and other data 493 such as driver driving patterns, driver fueling patterns, driver stopping patterns, driver pickup patterns, other driver patterns, data collected by and/or generated by at least one of the modules 110, 112, 406-408, traffic data, navigation data, map data, GPS/GNSS data, path data, speed data, and acceleration data, etc.

The vehicle control module 406 may control operation of the propulsion system 410, the video system including the display 420, 421, the audio system 422, the haptic devices, the brake system 476, the steering system 478, a seating system 196, and/or other devices and systems according to parameters set by the modules 110, 112, 406-408, 474. The seating system 496 may include seat sensors 497 for detecting presence of an occupant and/or change in occupants, for example, change in a driver. The vehicle control module 406 may set at least some of the parameters based on signals received from the sensors 450.

The vehicle control module 406 may receive power from the power sources 409, which may be provided to the propulsion system 410, the brake system 476, the steering system 478, the seating system 496, etc. Power supplied to the haptic devices, the motors 432, the brake system 476, the steering system 478, the seating system 496, and/or actuators thereof may be controlled by the vehicle control module 406 to, for example, adjust: motor speed, torque, and/or acceleration; braking pressure; steering wheel angle; pedal position; state of haptic devices; etc. This control may be based on the outputs of the sensors 450, the navigation module 414, the GPS and GNSS receiver 416, the data and information received from external devices, and the data and information stored in the memory 480.

The vehicle control module 406 may determine various parameters including a vehicle speed, a motor speed, a gear state, an accelerator position, a brake pedal position, an amount of regenerative (charge) power, an amount of auto start/stop discharge power, and/or other information. The vehicle control module 406 may control operations of the systems 410, 476, 478 based on the stated parameters. The vehicle control module 406 may display vehicle status information based on the stated parameters.

The host vehicle 400 can include various systems for assisting a driver, for performing autonomous operations, and/or for indicating to a vehicle occupant information regarding an environment of the host vehicle. For example, a host system may include a navigation system that provides map information indicating lane boundaries, street locations, speed limits, geographical locations of selected destinations, etc. The host system may provide the driver with instructions for driving to a selected destination and/or may perform autonomous operations such as braking, steering, and accelerating operations to drive the vehicle to the destination based on the map information.

As another example, the host vehicle 400 may include object detection and collision warning systems for detecting impending objects and performing countermeasures and/or taking evasive action to prevent a collision. The vehicle control module 406 determines locations of the objects relative to the host vehicle 400 and trajectories of the objects and the host vehicle 400. If it is determined that the host vehicle 400 is likely to collide with one of the objects, one or more warning signals may be generated to indicate to the driver and/or the object of concern of the potential collision. These warnings may be provided in addition to digital gateways and other information described herein. The vehicle control module 406 may also or alternatively perform one or more other countermeasures (e.g., apply brakes to decelerate the host vehicle, change a steering angle of the host vehicle, etc.) to prevent a collision.

FIG. 5 shows devices along the first example pathway 200 of FIG. 2 implementing certain communication protocols. The first example pathway 200 may include an input device, such as a mobile access device 500 or an initiating IoT device 502. The mobile access device 500 or IoT device 502 initiates communication with the central hub 206 or a voice or touch command is directly provided to the central hub 206. The mobile access device 500 and the IoT device 502 may communicate with the central hub 206 via a wireless network (e.g., Wi-Fi™) or a wireless personal area network (e.g., BLE). The central hub 206 may communicate with the vehicle 208 via a wireless network (e.g., Wi-Fi™) or a wireless personal area network (e.g., BLE). The vehicle 208 may communicate with the access secured device 202 via a wireless network (e.g., Wi-Fi™), a wireless personal area network (e.g., BLE), or using a UWB protocol. The stated communication between the devices 500, 502, 206, 202 and the vehicle 208 may be bidirectional.

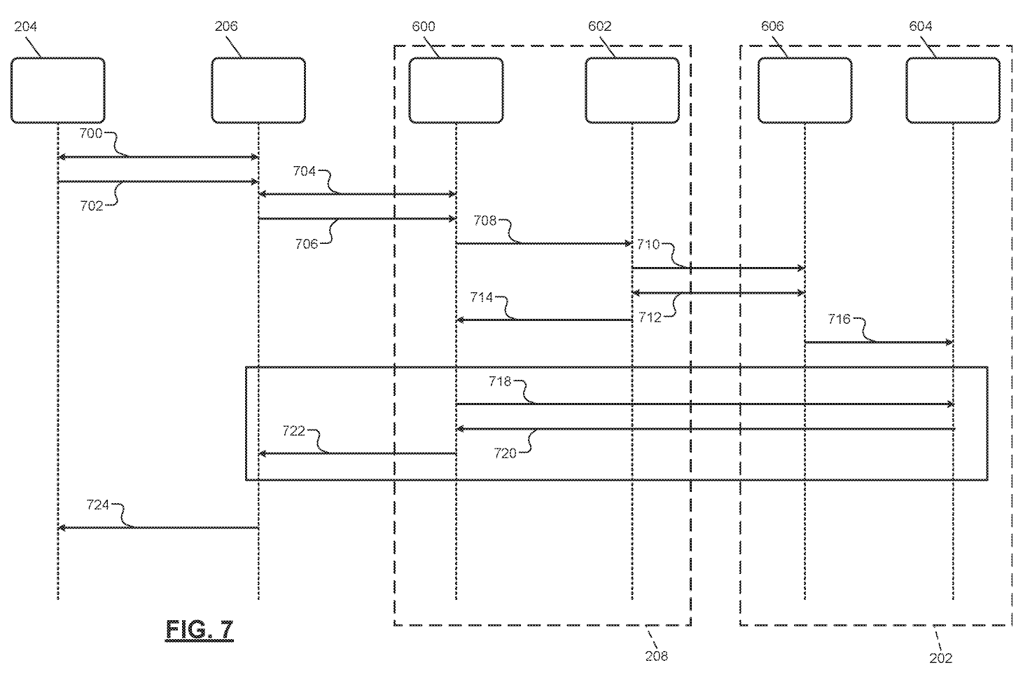

FIG. 6 shows the first example pathway 200 of FIG. 2 illustrating signal transmission. The pathway 200 may include the devices 500, 502, 206 and 202 and vehicle 208. The vehicle 208 includes a telematics module 600 and a virtual key module 602 similar to the modules 110, 112 of FIGS. 1 and 4. The access secured device 202 includes an access module 604, a ranging module 606 and one or more actuated devices 608. The actuated devices 608 may be a motor 610 (e.g., a garage door motor, a lock motor, etc.), a contactor switch 612, and/or other device 614 (e.g., a relay).

One of the devices 500, 502 authenticates with and negotiates a first session key SessKey1 with the central hub 206 and then provides a command 1 along with a MAC using the first session key SessKey1 to the central hub 206 to change a state of the access secured device 202. The central hub 206 then communicates with and authenticates to the telematics module 600 and negotiates a second session key SessKey2. The central hub 206 then relays the command to the telematics module 600 using the second session key SessKey2. The signals provided to the telematics module 600 are designated 2. The telematics module 600 instructs the VKM 602 to locate the access secured device 202. This is designated 3. The VKM communicates with the ranging module 606 to determine the location of the access secured device 202. In one embodiment, the ranging module 606 determines the location of the access secured device 202 and indicates the location to the VKM 602. The signals associated with this communication are designated 4, 5. The signal indicating the determined location back to the telematics module 600 is designated 6. The location is also provided to the access module 604. If the distance between the vehicle and the access secured device 202 satisfies the location requirement (i.e., less than a predetermined distance), then the telematics module 600 instructs the access module 604 to perform an action (e.g., unlock, lock, open, close, turn on, turn off, etc.). This instruction is designated 7. The access module 604 sends an ACK or NACK to the telematics module 600. The ACK or NACK is designated 8.

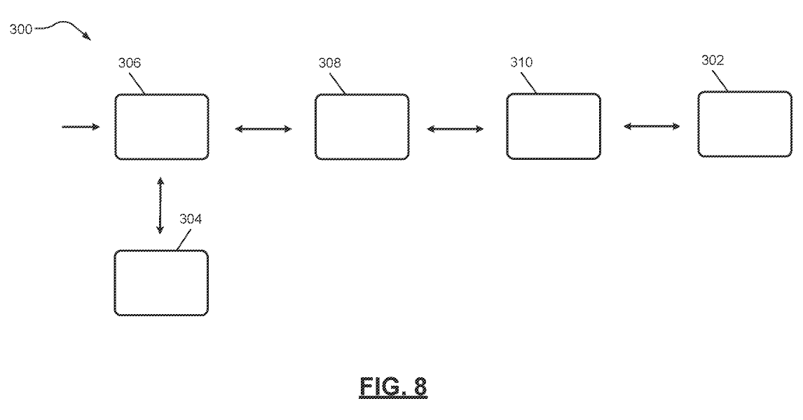

FIG. 7 shows a first method for controlling an access secured device and/or IoT device (e.g., the access secured device 202) via the central hub 206 and the vehicle 208 using the first example pathway 200 of FIG. 2. The following numerical designators 700, 702, 704, 706, 708, 710, 712, 714, 716, 718, 720, 722, and 724 represent both signal(s) transmitted and operation(s) being performed.

At 700, the input device 204 authenticates and negotiates the first session key SessKey1 (e.g., a symmetric key) with the central hub 206.

At 702, the input device 204 sends a command to the central hub 206 for the access secured device 202 to perform an action. The command includes a first MAC. The input device 204 uses the first session key SessKey1 and an algorithm to encrypt the command and generates and attaches the first MAC to the command. The command is encrypted using the first session key SessKey1.

At 704, the central hub 206 uses the first session key SessKey1 to decrypt the command and authenticates and negotiates a second session key SessKey2 with the telematics module 600.

At 706, the central hub 206 sends the command to the telematics module 600. The command includes a second MAC. The central hub 206 uses the second session key SessKey2 and an algorithm to encrypt the command and generates and attaches the second MAC to the command. The command is encrypted using the second session key SessKey2.

At 708, the telematics module 600 signals the VKM 602 to determine the location of the access secured device 202 relative to the vehicle 208. This signal may include a MAC.

At 710, the VKM 602 signals the ranging module 606 to determine the range (or distance) of the access secured device 202 relative to the vehicle 208. The signal may include a cryptographic (or digital) key for performing the commanded action.

At 712, the ranging module 606 may determine the range and signal the VKM 602 the range of the access secured device 202. In another embodiment, the ranging module 606 determines and transmits the location of the access secured device 202 to the VKM 602 and the VKM 602 then determines the range. In another embodiment, the VKM 602 transmits a signal to the ranging module 606 and receives a response back and estimates the range based on the amount of time to receive the response back.

At 714, the VKM 602 transmits the range and/or location to the telematics module 600. The VKM 602 may also transmit one or more cryptographic keys for commanding the access secured device to perform the action indicated in the command signal. At 716, the ranging module 606 may also signal the access module 604 the range and/or location.

In an embodiment, the following operations 718, 720, 722, 724 are performed, when the range (or distance) is less than a predetermined threshold (e.g., 20-40 m). In an embodiment, this distance check is performed when a door is being opened and/or unlocked and is not performed when the door is being closed and/or locked.

At 718, the telematics module 600 signals the access module 604 to perform the commanded action. This signal may include a cryptographic (or digital) key and/or a telematics module 600 signature and certificate.

At 720, the access module 604 transmits an ACK or NACK to the telematics module 600. This signal may include a transaction identifier (TXID). An ACK may be provided when the cryptographic key and a signature and certificate of the telematics module 600 are verified and valid and the commanded action is to be performed by the access secured device 202. A NACK may be provided when the cryptographic key and/or signature and certificate of the telematics module 600 are not verified or are invalid.

At 722, the ACK or NACK are forwarded from the telematics module 600 to the central hub 206 using the second session key SessKey2. This signal may include the TXID. The TXID is provided to identify a particular handshake/transaction and prevent use of an old TXID.

At 724, the central hub 206 forwards the ACK or NACK to the input device 204 using the first session key SessKey1. This may include the TXID.

FIG. 8 shows devices along the second example pathway 300 of FIG. 3 implementing certain communication protocols. The second example pathway 300 may include an input device, such as an initiating IoT device 304. The IoT device 304 initiates communication with the central hub 306 or a voice or touch command is directly provided to the central hub 306. The IoT device 304 may communicate with the central hub 306 via a wireless network (e.g., Wi-Fi™) or a wireless personal area network (e.g., BLE). The central hub 306 may communicate with a mobile access device 308 via a wireless network (e.g., Wi-Fi™) or a wireless personal area network (e.g., BLE). The mobile access device 308 may communicate with the vehicle 310 a wireless network (e.g., Wi-Fi™), a wireless personal area network (e.g., BLE), or via a UWB network. The vehicle 310 may communicate with the access secured device 302 via a wireless network (e.g., Wi-Fi™), a wireless personal area network (e.g., BLE), or using a UWB protocol. The stated communication between the devices 304, 306, 308, 302 and the vehicle 310 may be bidirectional.

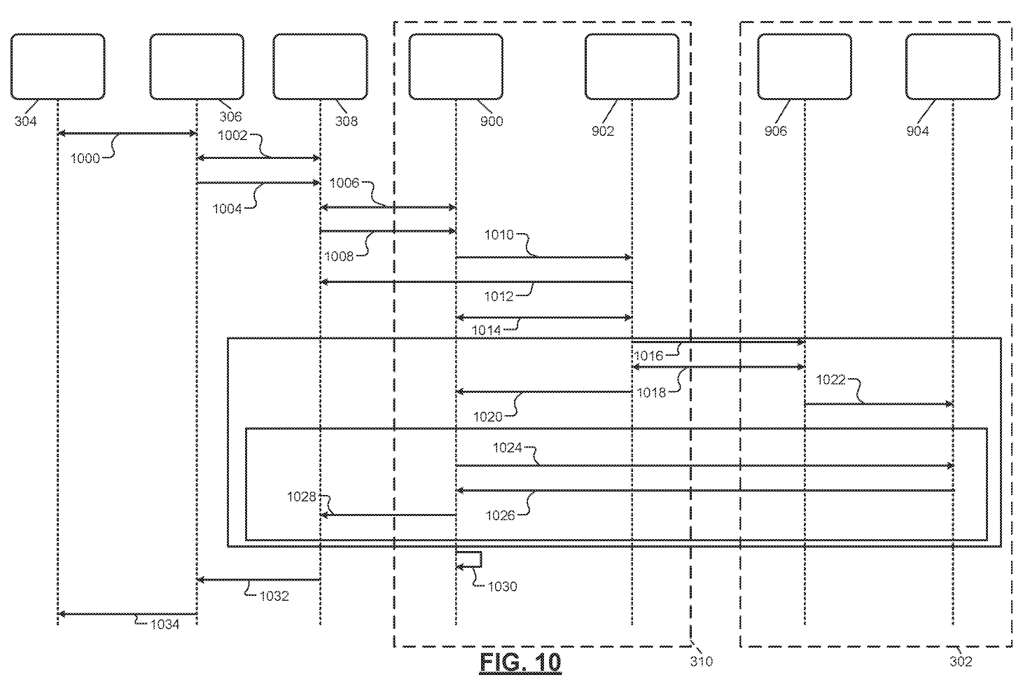

FIG. 9 shows the second example pathway 300 of FIG. 3 illustrating signal transmission. The pathway 300 may include the devices 304, 306, 308, and 302 and the vehicle 310. The vehicle 310 includes a telematics module 900 and a virtual key module 902 similar to the modules 110, 112 of FIGS. 1 and 4. The access secured device 302 includes an access module 904, a ranging module 906 and one or more actuated devices 908. The actuated devices 908 may be a motor 910 (e.g., a garage door motor, a lock motor, etc.), a contactor switch 912, and/or other device 914 (e.g., a relay).

In an embodiment, the IoT device 304 authenticates with and negotiates a first session key SessKey1 with the central hub 306 and then provides a command 1 along with a MAC using the first session key SessKey1 to the central hub 306 to change a state of the access secured device 302. In another embodiment, the IoT device communicates with the central hub 306 without negotiating a first session key and provides the command signal to the central hub 306.

The central hub 206 then communicates with and authenticates to the mobile access device 308 and negotiates a second session key SessKey2. In an embodiment, a first session key is negotiated if a first session key was not negotiated between the IoT device 304 and the central hub 306. The signals provided to the mobile access device are designated 2. The central hub 306 then sends a command to the mobile access device 308 using the session key negotiated between the central hub 306 and the mobile access device 308.

In an embodiment, the mobile access device 308 then communicates with and may authenticate to the telematics module 900 and may negotiate another session key SessKey2 or SessKey3. In an embodiment, the mobile access device 308 does not negotiate another session key with the telematics module 900. The mobile access device 308 relays the command to the telematics module 900. The command may be sent using the session key negotiated. The signals transmitted to the telematics module 900 are designated 3.

The telematics module 900 instructs the VKM 902 to locate the access secured device 302. This is designated 4. The VKM 902 communicates with the ranging module 906 to determine the location of the access secured device 302. In one embodiment, the ranging module 906 determines the location of the access secured device 302 and indicates the location to the VKM 902. The signals associated with this communication are designated 5, 6. The signal indicating the determined location back to the telematics module 900 is designated 7. The location is also provided to the access module 904. If the distance between the vehicle and the access secured device 302 satisfies the location requirement (i.e., less than a predetermined distance), then the telematics module 900 instructs the access module 904 to perform an action (e.g., unlock, lock, open, close, turn on, turn off, etc.). This instruction is designated 8. The access module 904 sends an ACK or NACK to the telematics module 900. The ACK or NACK is designated 9. The ACK or NACK is relayed back to the IoT device 304 via the central hub 306 and the mobile access device 308. The corresponding ACK/NACK signals are designated 10, 11. The signals 10, 11 may be MAC protected using the corresponding session keys previously negotiated and used for signals 1, 2 and/or 3.

FIG. 10 shows another signal flow diagram illustrating implementation of a second method for controlling an access secured device and/or IoT device (e.g., the access secured device 302) via the central hub 306 and the vehicle 310 using the second example pathway 300 of FIG. 3. The following numerical designators 1000, 1002, 1004, 1006, 1008, 1010, 1012, 1014, 1016, 1018, 1020, 1022, 1024, 1026, 1028, 1030, 1032, 1034, and 1036 represent both signal(s) transmitted and operation(s) being performed.

At 1000, the IoT device 304 may authenticate and negotiates a first session key SessKey1 (e.g., a symmetric key) with the central hub 306 and sends a command signal to the central hub 306. The command includes a first MAC. The IoT device 304 uses the first session key SessKey1 and an algorithm to encrypt the command and generates and attaches the first MAC to the command. The command is encrypted using the first session key SessKey1. In an embodiment, the IoT device 304 communicates with but does not negotiate a session key with the central hub 306 and the command does not include the first MAC.

At 1002, the central hub 306 may use the first session key SessKey1 to decrypt the command and authenticate to and negotiate a session key (first or second) SessKey1 or SessKey2 with the mobile access device 308, depending on whether a session key was negotiated at 1000.

At 1004, the central hub 306 uses the session key and an algorithm to encrypt the command and generates and attaches a first or second MAC to the command. The command is sent to the mobile access device 308.

At 1006, the mobile access device 308 uses the first session key SessKey1 to decrypt the command authenticates to and negotiates a session key (SessKey2 or SessKey3) with the telematics module 900.

At 1008, the mobile access device 308 uses the session key negotiated at 1006 and an algorithm to encrypt the command and generates and attaches a second or third MAC to the command. The command is sent to the telematics module 900.

At 1010, the telematics module 900 signals the VKM 902 to determine the location of the access secured device 302 relative to the vehicle 310. This signal may include the second or third MAC.

At 1012, the VKM 902 may signal the mobile access device 308 to determine a location of the mobile access device 308 relative to the access secured device 302. The signal may include a signature and certificate of the VKM 902.

At 1014, the VKM 902 may provide the location of the mobile access device 308 to the telematics module 900. In an embodiment, the following operations 1016, 1018, 1020, 1022, 1024, 1026, 1028, 1030 are performed when the distance of the mobile access device 308 is less than a first threshold from the access secured device 302.

At 1016, the VKM 902 signals the ranging module 906 to determine the range (or distance) of the vehicle 310 relative to the access secured device 302. The signal may include a cryptographic (or digital) key.

At 1018, the ranging module 906 may determine the range and signal the VKM 902 the range of the vehicle 310. In another embodiment, the ranging module 906 determines and transmits the location of the access secured device 302 to the VKM 902 and the VKM 902 then determines the range. In another embodiment, the VKM 902 transmits a signal to the ranging module 906 and receives a response back and estimates the range based on the amount of time to receive the response back.

At 1020, the VKM 902 transmits the range and/or location to the telematics module 900. The VKM 902 may also transmit one or more cryptographic keys for commanding the access secured device 302 to perform the action indicated in the command signal.

At 1022, the ranging module 906 may also signal the access module 904 the range and/or location of the vehicle 310. In an embodiment, the following operations 1024, 1026, 1028, 1030 are performed when the distance of the vehicle 310 is less than a second threshold from the access secured device 302. The second threshold may be the same or different than the first threshold. In an embodiment, the first and second thresholds are 20-40 m.

In an embodiment, this distance checks of operations 1010, 1012, 1014, 1016, 1018, 1020, 1022 are performed when a door is being opened and/or unlocked and is not performed when the door is being closed and/or locked.

At 1024, the telematics module 900 signals the access module 904 to perform the commanded action. This signal may include a cryptographic (or digital) key and/or a telematics module 900 signature and certificate.

At 1026, the access module 904 transmits an ACK or NACK to the telematics module 600. The ACK/NACK signal may include a TXID. An ACK may be provided when the cryptographic key and a signature and certificate of the telematics module 600 are verified and valid and the commanded action is to be performed by the access secured device 302. A NACK may be provided when the cryptographic key and/or signature and certificate of the telematics module 600 are not verified or are invalid.

At 1028, the ACK or NACK are forwarded from the telematics module 600 to the central hub 306 using the corresponding session key (e.g., the second session key SessKey2 or third session key SessKey3). This signal may include the TXID and the corresponding MAC. The TXID is provided to identify a particular handshake/transaction and prevent use of an old TXID.

At 1030, the telematics module 900 aborts due to i) the distance of the mobile access device 308 not satisfying the first predetermined threshold, ii) the distance of the vehicle 310 not satisfying the second predetermined threshold, and/or the distance of the mobile access device 308 not being consistent with the distance of the vehicle 310.

At 1032, the mobile access device 308 forwards the ACK or NACK to the central hub 306 using the corresponding session key (e.g., the first session key SessKey1 or the second session key SessKey2). This signal may include the TXID and corresponding MAC. At 1034, the central hub transmits the ACK or NACK to the IoT device 304. This may be done using the first session key SessKey1 and may include the TXID.

The above examples provide a protocol/sequence of steps to enable communication between a smart home endpoint (or IoT device in the hole) and an IoT device outside of (or not connected to) a home ecosystem. The examples include security mechanisms to mitigate forgery, replay, and distance reduction attacks. The examples use a second UWB-capable device (e.g., mobile access device) in addition to a first UWB-capable device (e.g., telematics module of a vehicle) to verify correctness of a first range measurement made relative to the vehicle. The examples further include performing a consistency check including comparing a range of a mobile access device and a range of a vehicle relative to an access secured device.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An access system for controlling operation of an access secured device, the access system comprising:
a telematics module of a vehicle configured to receive a command from a central hub of an ecosystem of a building or a mobile access device, wherein the command instructs the access secured device to perform an action, wherein the access secured device is located within, on or proximate to the building and is not in communication with the central hub, and wherein the ecosystem includes a plurality of Internet of things (IoT) devices at least one of connected to and controlled by the central hub; and
a virtual key module configured to determine a location of the vehicle relative to the access secured device,
the telematics module is configured, based on the location of the vehicle, to signal the access secured device to perform the commanded action.

2. The access system of claim 1, wherein:
the virtual key module is configured to determine a distance of the vehicle relative to the access secured device, and based on the distance, signal the telematics module the distance; and
the telematics module is configured, based on the distance, to signal the access secured device to perform the commanded action.

3. The access system of claim 1, wherein the access secured device is located within or on the building and is not configured to communicate with the central hub.

4. The access system of claim 1, wherein the access secured device is a garage door opener, a door lock of the building, or a vehicle charger of the building.

5. The access system of claim 1, wherein the telematics module is configured to authenticate the central hub and negotiate a session key with the central hub and receive the command from the central hub including a message access code of the session key.

6. The access system of claim 5, further comprising
the central hub configured to i) authenticate an input device, which initiated the command, ii) negotiate another session key with the telematics module, and iii) transmit the command to the telematics module using the another session key, wherein the command is sent along with another message access code to the telematics module.

7. The access system of claim 1, wherein the telematics module is configured to authenticate the mobile access device and negotiate a session key with the mobile access device and receive the command from the mobile access device including a message access code of the session key.

8. The access system of claim 7, further comprising the central hub configured to i) authenticate an Internet of things device, which initiated the command, ii) negotiate another session key with the mobile access device, and iii) transmit the command to the mobile access device using the another session key, wherein the command is sent along with another message access code to the mobile access device.

9. The access system of claim 1, further comprising the central hub configured to receive the command from an Internet of things device and forward the command to the telematics module.

10. The access system of claim 1, further comprising the central hub configured to receive the command from an Internet of things device and forward the command to the mobile access device,
wherein the telematics module is configured to receive the command from the mobile access device.

11. An access method for remotely accessing and controlling operation of an access secured device, the access method comprising:
receiving at a telematics module of a vehicle a command from a central hub of an ecosystem of a building or a mobile access device,
wherein the command instructs the access secured device to perform an action,
wherein the access secured device is located within, on or proximate to the building and is not in communication with the central hub, and
wherein the ecosystem includes a plurality of Internet of things (IoT) devices at least one of connected to and controlled by the central hub;
determining a location of the vehicle relative to the access secured device; and
based on the location of the vehicle, signaling the access secured device to perform the commanded action.

12. The access method of claim 11, further comprising:
determining a distance of the vehicle relative to the access secured device, and based on the distance, signal the telematics module the distance; and
based on the distance, signaling the access secured device to perform the commanded action.

13. The access method of claim 11, wherein the access secured device is located within or on the building and is not configured to communicate with the central hub.

14. The access method of claim 11, wherein the access secured device is a garage door opener, a door lock of the building, or a vehicle charger of the building.

15. The access method of claim 11, further comprising authenticating the central hub, negotiating a session key with the central hub, and receiving the command from the central hub including a message access code of the session key.

16. The access method of claim 15, further comprising, via the central hub, i) authenticating an input device, which initiated the command, ii) negotiating another session key with the telematics module, and iii) transmitting the command to the telematics module using the another session key, wherein the command is sent along with another message access code to the telematics module.

17. The access method of claim 11, further comprising authenticating the mobile access device, negotiating a session key with the mobile access device, and receiving the command from the mobile access device including a message access code of the session key.

18. The access method of claim 17, further comprising i) authenticating an Internet of things device, which initiated the command, ii) negotiating another session key with the mobile access device, and iii) transmitting the command to the mobile access device using the another session key, wherein the command is sent along with another message access code to the mobile access device.

19. The access method of claim 11, further comprising receiving the command from an Internet of things device and forwarding the command to the telematics module via the central hub.

20. The access method of claim 11, further comprising receiving the command from an Internet of things device and forward the command to the mobile access device via the central hub,
wherein the telematics module is configured to receive the command from the mobile access device.
